(19) United States
(12) Patent Application Publication
(10) Pub. No.: US 2023/0150364 A1
(43) Pub. Date: May 18, 2023

(54) MOTOR VEHICLE ELECTRONIC IDENTIFICATION, NOTIFICATION AND LEGAL WARNING BANNER DEVICE

(71) Applicants: Sterling Jerome McKoy, Omaha, NE (US); Anthony Antoine Hartwell, Flint, MI (US)

(72) Inventors: Sterling Jerome McKoy, Omaha, NE (US); Anthony Antoine Hartwell, Flint, MI (US)

(21) Appl. No.: 17/985,426

(22) Filed: Nov. 11, 2022

Related U.S. Application Data
(60) Provisional application No. 63/360,956, filed on Nov. 17, 2021.

(51) Int. Cl. B60K 35/00; G06V 40/13

(52) U.S. Cl. CPC B60K 35/00; G06V 40/13; B60K 2370/16; B60K 2370/334; B60K 2370/1438; B60K 2370/785

(57) ABSTRACT

An app and novel device designed for motor vehicles and motorcycles is disclosed that can be activated, via a thumbprint or identification number of a citizen, during routine traffic stops, which depicts an electronic/digital copy of the citizen's driver's license, insurance policy, registration and relevant, controlling Supreme Court case law governing citizen-police encounters, on a chosen portion of the front windshield (on the inside), the drivers or the back window of a vehicle.

### CROSS-REFERENCE TO OTHER APPLICATIONS

The present application claims the benefit of U.S. Provisional Application No. 63/360,956, entitled “NOVEL MOTOR VEHICLE ELECTRONIC IDENTIFICATION, NOTIFICATION AND LEGAL WARNING BANNER DEVICE,” filed Nov. 17, 2021, the content of which is incorporated herein by reference in its entirety for all purposes.

### TECHNICAL FIELD

This disclosure relates to a communications system for matching users of the system. In particular, the disclosure relates to a communications system that matches freelancers with clients, both geographically convenient and where users can share information.

### BACKGROUND

In 2015, the United States Supreme Court decided, in the context of traffic stops conducted by police officers; that, “[A] police stop exceeding the time needed to handle the matter for which the stop was made violates the Constitution's shield against unreasonable seizures. A seizure justified only by a police-observed traffic violation, therefore, becomes unlawful if it is prolonged beyond the time reasonably required to complete the mission of issuing the ticket for the violation.” United States vs: Rodriquez, 575 U.S. 348, 349 (2015).

Subsequent to the Rodriquez decision, federal and State appellate and district courts have routinely held that traffic stops which surpass, for example, even 25 seconds, after the conclusion of a lawful traffic stop is completed, without any showing of reasonable suspicion or probable cause a crime has been committed, violates a defendant's constitutional right to be free from unreasonable search and seizures. See e.g., United States vs, Campbell, 912 F.3d 1340, 1353 (11th Cir. 2019)(finding unanimously that police violated the Fourth Amendment, in light of Rodriguez, when they extended a stop by twenty-five seconds with questions about contraband)(emphasis added); United States—V; McGowan; 2021 U.S. Dist. LEXIS-126194*12 (D.Nev. 2021) (similar finding based on forty second delay unconstitutionally caused by police officer after conclusion of a lawful traffic stop).

Armed with Rodriquez, several federal district courts, likewise, have shunned the multi-decade practice of police officers imposing interrogatory questions-upon motorist that are unrelated to and outside the scope of the purposes of the initial traffic stop—which, by design, impermissibly, in most instances, lengthens the time span of a lawful detention. See e.g., United States vs. Callison. 436 F. Supp. 3d 1218, 1226 (S.D. Iowa 2020) (citing cases).

Although seemingly innocuous in nature, Rodriquez, in short, was a transformational, ground-breaking legal decision. This is so, first of all, because of the Supreme Court's exhortation that, outside of providing a license, registration and insurance, citizens have no duty to speak to or otherwise respond to police officer inquiries during the course of lawful traffic stops, See generally Berkemer vs. McCarty. 468 U.S. 420,439 (1984) (citing Terry vs. Ohio, 392. U.S. 1, 20 (1968) for the proposition that, in the context of a traffic stop, a “detainee is not obligated to respond to officers questions.”); Second, is the general safety of citizens compelled, through omission or manipulation, to arbitrarily interact with police officers, a lot of times to their detriment, as can be demonstrated by the litany of motorist killed during routine traffic stops over the past several decades, a recurring event in America that was the driving force resulting in the unjustified killing of George Floyd and the global protest, thereafter, against police-officer-sanctioned-violence-against-citizens, in 2021. Third, in light of the world-wide Covid-19 pandemic, the transference of germs and bacteria among human beings””—i.e., citizens handing police officers their, inter alia, drivers licenses—has become an issue of national import.

Consequently, a need exists for a technological, electronic identification, notification legal warning banner device (“electronic warning banner device” hereinafter) designed for motor vehicles that can be activated by citizens during routine traffic stops, which depicts an electronic copy of the citizens driver's license, registration, insurance (and any other license/certifications, etc.) and relevant Supreme Court law governing citizen-police encounters, on a chosen portion of the front (drivers or rear) windshield (or window) of a motorist vehicle, thereby providing the proper notice to police officers that said citizen does not want to talk or otherwise interact with said police officers. The electronic warning-banner device, via our app, also downloads relevant data pertinent to the location, length and duration of the stop, and, among other things, the race, gender and age of the driver.

Finally, the same service may be provided via a citizen's cell phone. Through their cell phone, when a citizen is pulled over by police officers, they can press their thumbprints into an appointed portion of the phone (or type identification numbers into our app) to obtain the same results from out of our projectile device installed in the vehicle, depicting the same documentation and legal information in the front, driver's or rear window of a vehicle for police officers to view. The electronic warning-banner device will also be available for the front windshield or side mirrors of motorcycles.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

The present disclosure comprises an electronic thumbprint device which will generally be configured or installed somewhere on the center counsel of the motor vehicle by way of existing nano suction technology (generally utilized for cell phones, that attaches to smooth surfaces) attached to the back portion of the thumbprint device. The said thumbprint device will be connected, via WiFi, Bluetooth ability, to another electronic projector device (linked into our database/app, that's downloaded with copies of the motorist's driver's license, insurance, registration, etc.) that'll be attached to the front or driver's side (or rear) window inside the vehicle by way of nano suction technology. The thumbprint mechanism and projector, will have GPS capabilities, will be removable at any time, and rechargeable no different than a cell phone.

Or, via smart phone devices, our app and database, individuals will be able to utilize their fingerprint on an appointed portion of the face of the smartphone (or log in via our app with an identification number) to activate the projector device mechanism installed in the vehicle, which depicts the license, insurance, registration, etc., in the front, drivers or rear window for the officers review, and alternative to the thumbprint device.

The disclosure provides an electronic/digital license, insurance policy, registration and legal warning banner device that categorically precludes law enforcement officers from lawfully engaging in any unwanted conversation or interaction with motorist during traffic stops, as a result of the law enforcement officer being put on notice, before even so much as requesting the driver's license, insurance policy and vehicle/motorcycle registration, that the citizen/driver is exercising his/her rights, pursuant to Supreme Court law and the First Amendment, to refrain from speaking to the law enforcement officer.

The disclosure provides an electronic/digital license, insurance policy, registration and legal warning banner device that completely eradicates any transference of germs and/or bacteria between citizens and police officers during traffic stops, by eliminating the need for the citizen to physically hand the police officer a copy of his/her driver's license, insurance policy and registration, which can be seen, read, examined, and copied by the officer who conducted the traffic stop, taken back to the police cruiser to be verified, checking whether or not the driver has any existing warrants or suspended driver's license, or any other outstanding obligations that must be attended to.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 depicts an example of the electronic thumbprint device 100 according to various aspects of the present disclosure.

FIG. 2A is a side perspective of an aspect of the electronic thumbprint device, according to various aspects of the present disclosure.

FIG. 2B illustrates an example of the charging cord utilized to charge the thumbprint device.

FIG. 3A illustrates a projector device according to an aspect of the disclosure.

FIG. 3B is an example flow chart of how the information from the electronic fingerprint device is projected.

FIG. 4 illustrates an example aspect of an interface of a portable device used for entering a thumbprint and/or identification number through an app, according to various aspects of the present disclosure.

FIG. 5 illustrates an example aspect of a projector device attached to a front windshield, according to various aspects of the present disclosure.

FIG. 6 is an example of a text of a legal warning banner that will be displayed, according to various aspects of the present disclosure.

FIG. 7 is an example flow chart for acts taken to implement the aspects of the disclosure by an app for activating the electronic warning banner device.

### DETAILED DESCRIPTION

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

The terminology used herein is for the purposes of describing particular aspects only and is not intended to be limiting of the disclosure. As used herein, the term “and/or” includes any and all combinations of one or more of the associated listed items. As used herein, the singular forms “a” “an” and “the” are intended to include the plural forms as well as the singular forms, unless the context clearly indicates otherwise. It will be further understood that the terms “comprises” and/or “comprising” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosure, it will be understood that a number of techniques and steps are disclosed. Each of these has individual benefit and each can also be used in conjunction with one or more, or in some cases, all of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the disclosure and the claims.

The intricacies of the electronic warning banner device are discussed herein. In the following description, for the purposes of explanation, numerous specific details are set forth in order to provide a thorough understanding of the present disclosure. It will be evident, however, to one skilled in the art that the present disclosure may be practiced without specific details.

The present disclosure is to be considered as an exemplification of the disclosure and is not intended to limit the disclosure to the specific aspects illustrated by the figures or description below.

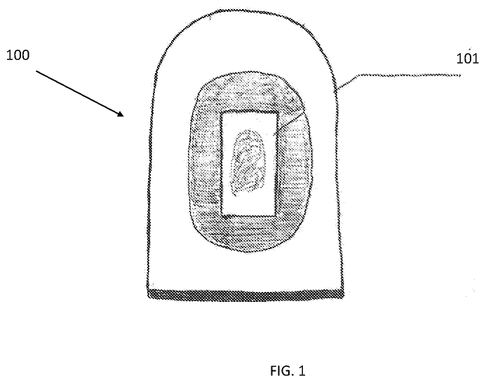

The present disclosure will now be described by referencing the appended figures representing certain aspects. FIG. 1 depicts an example of an electronic thumbprint device 100 according to various aspects of the present disclosure, which may measure out to around 2.0 inches in width, 3.0 inches in length, 1.0 inches in depth. The electronic thumbprint device 100 includes a thumbprint reader 101, positioned for easy access by a user's thumbprint to activate and control.

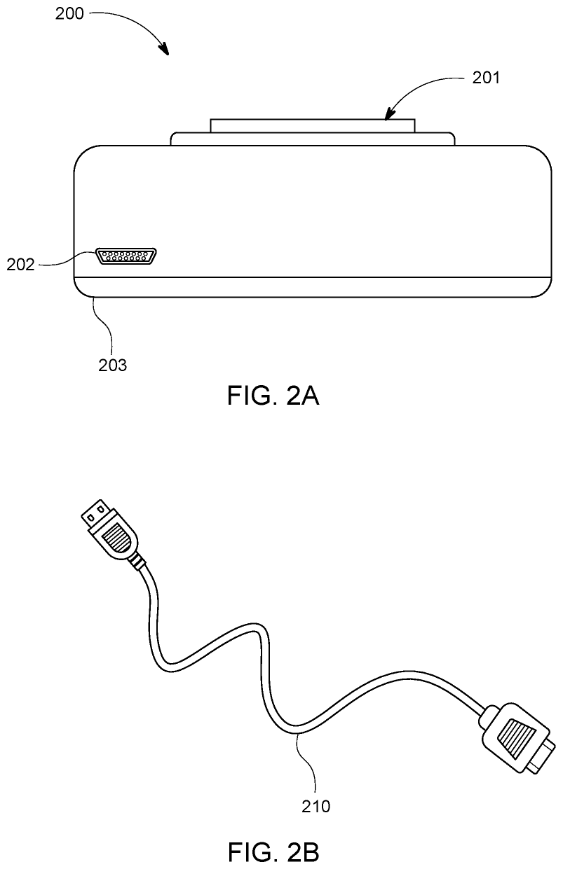

FIG. 2A is a side perspective of an aspect of the electronic thumbprint device 200. The electronic thumbprint device 200 includes a thumbprint reader 201 seen in in a side perspective. The electronic thumbprint device 200 includes a fingerprint portal 202 for the individual to utilize to activate the electronic aspect of a charging cord necessary to charge the electronic thumbprint device 200. Within one of the aspects of the electronic thumbprint device 200, it will be charged up ready for use, no different from a cell phone. The electronic thumbprint device 200 includes a suction cup attachment mechanism 203. In an aspect, the suction cup attachment is a nano suction technology suction cup on the bottom of the electronic thumbprint device 200 (or similar methods available to achieve the same result known to one of skill in the art) which will be utilized to attach the electronic thumbprint device 200 to any smooth surface on the center console or front middle panel of a vehicle.

FIG. 2B illustrates an example of the charging cord 210 utilized to charge the thumbprint device, according to various aspects of the present disclosure described herein. The charging cord 210 may comprise a USB charging cable, such as micro-USB, Type C, Lightning, Thunderbolt, MagSafe or any charging cord interface known to one of skill in the art.

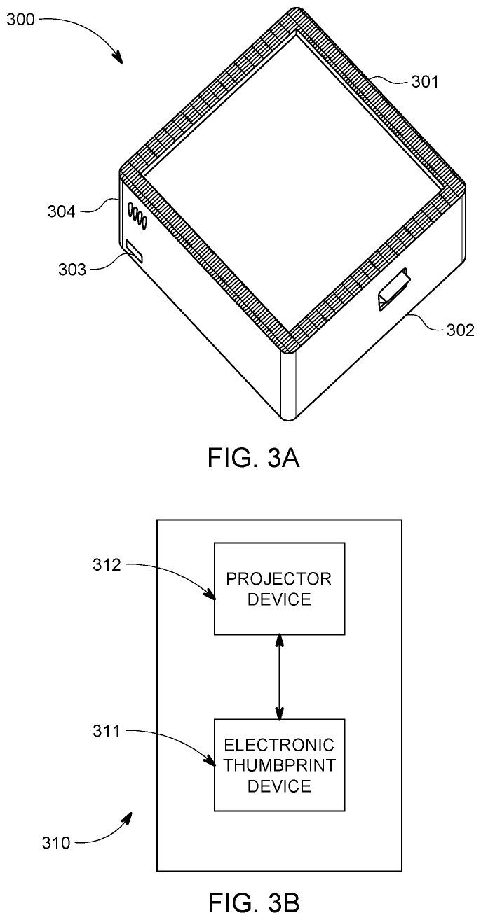

FIG. 3A illustrates a projector device 300 according to an aspect of the disclosure. The projector device 300 is in electrical, electromechanical or mechanical communication with the electronic thumbprint device 100. In an aspect of the disclosure, the projector device 300 is in electromagnetic communication with electronic thumbprint device 100 or 200. In aspects of the disclosure, the projector device 300 is in communication with the electronic thumbprint device 100 or 200 through a wireless connection such as Wi-Fi, Bluetooth, near-field communication (NFC), cellular or other known wireless technologies.

FIG. 3B illustrates an electronic banner warning device 310. The electronic warning device 310 comprises an electronic thumbprint device 311 (as described in and according to aspects of the disclosure in relation to FIG. 1 and FIG. 2 herein) in communication with a projector device 312 (as described in and according to aspects of the disclosure in relation to FIG. 3 herein).

In an aspect of the disclosure, the projector device 300 may measure out to around 3.5 inches in width, 3.5 inches in length, and 1.5 inches in depth. In some aspects, the projector device 300 may be smaller. In an aspect, the projector device 300 includes a suction cup attachment 301. In an aspect, the suction cup attachment may be a nano suction technology attached to the top of the projector device 300, utilized to connect the projector device 300 to a windshield, driver's side window or rear window of the vehicle (not shown). Both the projector device 300 and the electronic thumbprint device 100 or 200 can either remain on the window(s) (i.e., projector) or somewhere on the center console (i.e., thumbprint device) or be put in place when pulled over by law enforcement officials.

In an aspect, the projector device 300 includes a projector lens 302 out of which an electronic projection of an individual's license, insurance policy, registration and/or legal warning banner will appear once the electronic warning device 310 is activated by way of the individual pressing his thumbprint into one of, or any variation of one of the electronic thumbprint devices 100 or 200.

The projector device 300 includes a charging port 303 for the projector device 300. The charging port 303 may use a charging cord such as the charging cord 210 illustrated and described in relation to FIG. 2.

In an aspect of the disclosure, the projector device 300 may include a vent 304 attached to or embedded in the projector device 300. The vent 304 may be configured to cool the projector device 300 by allowing warm air to escape the projector device 300 and maintain a suitable operating temperature for components within the projector device.

The electronic thumbprint device 100 or 200 may include GPS, GLNSS or other positional communications technologies, and will be utilized by an individual to activate the electronic warning banner device 310 and a related app operable to activate and interact with the electronic warning banner device 310.

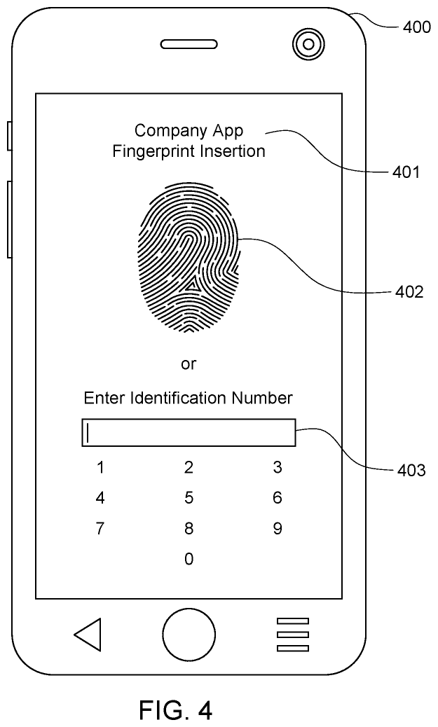

FIG. 4 illustrates an example aspect of an interface, such as a graphical user interface (“GUI”) of a portable device, such as smartphone 400, where a company app 401 is displayed, and the section where an individual must either utilize his thumbprint 402 or type in an allotted identification number 403 to activate the electronic warning banner device 310 upon being pulled over by law enforcement officials. The smartphone 400 may also be in the form of a wearable device, such as a smart watch or other wearable known to one of skill in the art. In an aspect of the disclosure, the GUI of the smartphone 400 may be a voice-activated interface, TTY interface or other alternative input mechanisms for users of varying capabilities or disabilities.

Before utilizing the electronic warning banner device, the individuals who opt to purchase the service and electronic warning banner device 310, will provide their thumbprint, a valid hard copy of the driver's license, proof of insurance and registration via the company app, to be downloaded into a company database. If individuals do not want to share their fingerprints, they may be provided an identification number for the purposes of activating the electronic warning banner device 310 upon being pulled over by law enforcement officials.

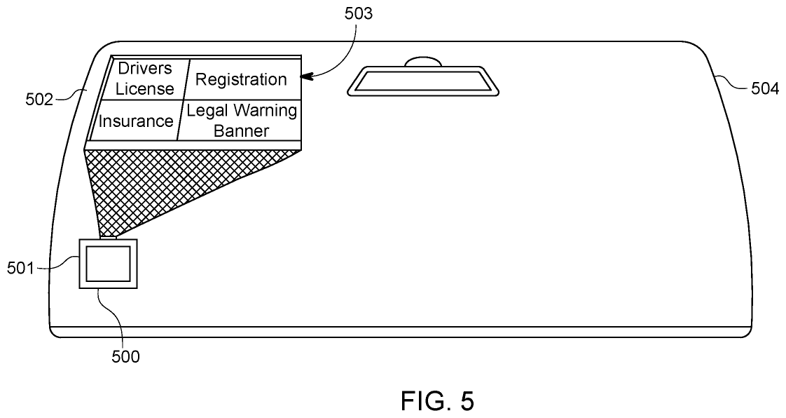

FIG. 5 illustrates an example aspect of a projector device 500 attached to a front windshield by way of nano suction technology typically utilized on cell phones to achieve the same result of attaching to flat, smooth surfaces or other attachment mechanisms known to one of skill in the art. The attached projector device 501 may illuminate an electronic image 502 of the driver's license, registration, insurance and legal warning banner 503 on the front windshield of a window 504, after being activated by way of the electronic thumbprint device 100 or 200. The projected electronic image 502 may be positioned in any suitable region of the front windshield of the window 504, but in some aspects, will be positioned on the left hand corner of the windshield of the window 504.

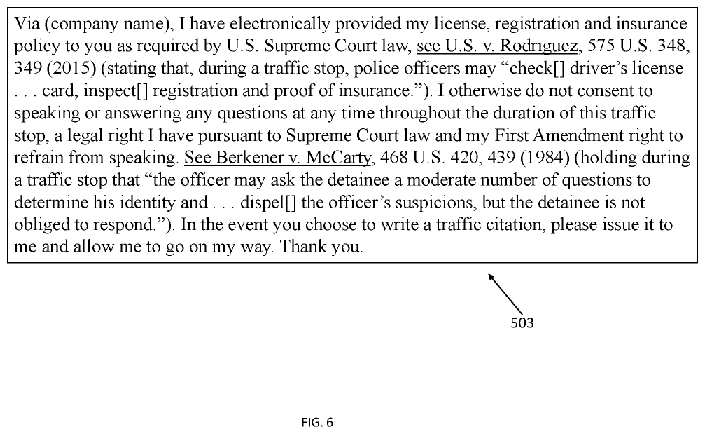

FIG. 6 is an example of a general variation of the text of the legal warning banner 503 that will be displayed, along with the driver's license, insurance policy and registration, when the electronic warning banner device is activated either by fingerprint or identification number. An example text, though not limiting, may read “Via (company name), I have electronically provided my license, registration and insurance policy to you as required by U.S. Supreme Court law, see U.S. v. Rodriguez, 575 U.S. 348, 349 (2015) (stating that, during a traffic stop, police officers may “check[] driver's license . . . card, inspect[] registration and proof of insurance.”). I otherwise do not consent to speaking or answering any questions at any time throughout the duration of this traffic stop, a legal right I have pursuant to Supreme Court law and my First Amendment right to refrain from speaking. See Berkener v. McCarty, 468 U.S. 420, 439 (1984) (holding during a traffic stop that “the officer may ask the detainee a moderate number of questions to determine his identity and . . . dispel[] the officer's suspicions, but the detainee is not obliged to respond.”). In the event you choose to write a traffic citation, please issue it to me and allow me to go on my way. Thank you.” Other examples of similar wording may be used, so the above example text may be modified or substituted with other content that satisfies the goal of the disclosure.

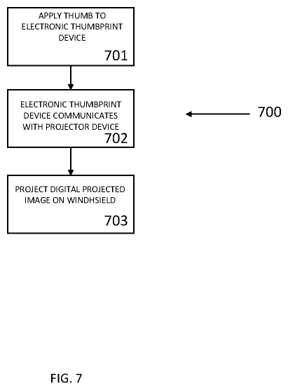

FIG. 7 is an example flow chart 700 for acts taken to implement the aspects of the disclosure by the app 401 for activating the electronic warning banner device 310. In act 701, a user applies his/her thumb to the electronic thumbprint device 100, when the user has need to use the electronic warning banner device 310. This may occur when the user sees a law enforcement vehicle flashing its lights behind the user's vehicle. Another instance requiring use of the electronic warning banner device 310 may occur when a law enforcement officer is approaching the user's vehicle either from the law enforcement officer's vehicle or from a different direction.

In act 702, the electronic thumbprint device 100 communicates with a projector device 300 via a wired or wireless connection. The electronic thumbprint device 100 may send a “wake-up” or synchronization message to notify the projector device 300 to start up and power on a projector lens 302.

In act 703, the projector device 300, through the projector lens 302, projects a digital projected image on an area of a windshield of the user's vehicle. The digital projected image may include images of the driver's license, insurance policy, registration and a legal warning banner on an appointed area of the window; and the information that is automatically downloaded to a database via the app, including, but not limited to, the 1) name of driver; 2) their age; 3) their race; 4) gender; 5) the time of the traffic stop; 6) complete duration of the traffic stop, from beginning to end; 7) the speed the vehicle was driving; and 8) compilation of other pertinent data that the company accumulates in general and over time and will be made available to customer via the app, and other business consumers who purchase certain kinds of data related to the service our company provides.

The flow chart and acts illustrated in FIG. 7 may be implemented on an apparatus comprising a processor and a memory comprising computer program code for one or more programs, where the computer program code is configured to cause the processor of the apparatus to implement the acts illustrated in FIG. 7.

The sequence diagrams in FIG. 7 may be encoded in a signal bearing medium, a computer readable medium such as a memory, programmed within a device such as one or more integrated circuits, or processed by a controller or a computer. If the methods are performed by software, the software may reside in a memory resident to or interfaced to the any type of non-volatile or volatile memory interfaced or resident to the memory incorporated in the components in a communications network. Such memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “computer program code”, “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A method for displaying an electronic warning banner to a law enforcement officer during a traffic stop of a driver, the method comprising:
providing an electronic warning banner device for the driver to use during the traffic stop, where the electronic warning banner device comprises an electronic thumbprint device attached to an area of an interior of the vehicle by a first suction cup attachment and in communication with a projector device equipped with a projector lens, the projection device attached to a window of a vehicle by a second suction cup attachment;
upon receiving a thumbprint application by the driver upon the electronic thumbprint device, communicating between the electronic thumbprint device and the projector device;
projecting for display, by the projector lens of the projector device, the electronic warning banner upon an appointed area of the window of a vehicle operated by the driver.

2. The method of claim 1, where projecting for display the electronic warning banner comprises projecting at least one of an image of a driver's license, an image of an insurance policy, an image of vehicle registration and a legal warning banner advising the law enforcement officer of legal rights of the driver during the traffic stop.

3. The method of claim 1, where projecting for display the electronic warning banner comprises projecting the electronic warning banner upon an appointed area of a windshield of the vehicle operated by the driver.

4. The method of claim 2, where the legal warning banner comprises a message of controlling constitutional legal case law and legal warnings associated with the legal rights of the driver and advising the law enforcement officer what the driver will do or not do to comply with the law enforcement officer during the traffic stop.

5. The method of claim 1, where providing the electronic warning banner device comprises providing a thumbprint reader area upon the electronic thumbprint device, where the thumbprint reader is configured to identify a pre-entered thumbprint associated with the driver.

6. The method of claim 5, where the thumbprint reader area is positioned on a touch screen of a portable electronic device.

7. The method of claim 6, where the portable electronic device comprises a smartphone, a tablet or a wearable electronic device capable of touchscreen interface.

8. The method of claim 1, where providing the electronic warning banner device comprises providing an app upon a portable device, where the app is configured to display a thumbprint recognition area, an identification number entry area or a combination thereof.

9. An electronic warning banner device for providing information to a law enforcement officer during a traffic stop of a vehicle, comprising:
an electronic thumbprint device attached to an area of an interior of the vehicle by a first suction cup attachment, the electronic thumbprint device comprising a thumbprint reader area configured to receive a pre-entered thumbprint of a driver of the vehicle;
a projector device equipped with a projector lens, where the electronic thumbprint device is in communication with the projector device, the projection device attached to a window of the vehicle by a second suction cup attachment, and where the projector device projects, by the projector lens, an electronic warning banner upon an appointed area of the window of the vehicle operated by the driver.

10. The electronic warning banner device of claim 9, where the electronic warning banner is projected upon an appointed area of a windshield of the vehicle operated by the driver.

11. The electronic warning banner device of claim 9, where the electronic warning banner comprises at least one of an image of a driver's license, an image of an insurance policy, an image of vehicle registration and a legal warning banner advising the law enforcement officer of legal rights of the driver during the traffic stop.

12. The electronic warning banner device of claim 11, where the legal warning banner comprises a message of controlling constitutional legal case law and legal warnings associated with the legal rights of the driver and advising the law enforcement officer what the driver will do or not do to comply with the law enforcement officer during the traffic stop.

13. The electronic warning banner device of claim 9, where the thumbprint reader area is positioned on a touch screen of a portable electronic device.

14. The electronic warning banner device of claim 9, where the portable electronic device comprises a smartphone, a tablet or a wearable electronic device capable of touchscreen interface.

15. The electronic warning banner device of claim 14, further comprising an app upon a portable device, where the app is configured to display a thumbprint recognition area, an identification number entry area or a combination thereof

16. An apparatus for displaying an electronic warning banner to a law enforcement officer during a traffic stop of a driver operating a vehicle, the apparatus comprising:
a thumbprint detector device, attached to an area of an interior of the vehicle by a first suction cup attachment;
a projector device in communication with the thumbprint detector device, the projection device attached to a window of the vehicle by a second suction cup attachment;
a processor; and
a memory comprising computer program code for one or more programs, where the computer program code is configured to cause the processor of the apparatus to:
receive a thumbprint application by the driver upon the electronic thumbprint device;
communicate, upon receipt of the thumbprint application, between the electronic thumbprint device and the projector device; and
display the electronic warning banner upon an appointed area of a window of the vehicle operated by the driver.

17. The apparatus of claim 16, where the electronic warning banner comprises at least one of an image of a driver's license, an image of an insurance policy, an image of vehicle registration and a legal warning banner advising the law enforcement officer of legal rights of the driver during the traffic stop.

18. The apparatus of claim 16, where the legal warning banner comprises a message of controlling constitutional legal case law and legal warnings associated with the legal rights of the driver and advising the law enforcement officer what the driver will do or not do to comply with the law enforcement officer during the traffic stop.

19. The apparatus of claim 16, further comprising an app upon a portable device, where the app is configured to display a thumbprint recognition area, an identification number entry area or a combination thereof

20. The apparatus of claim 16, further comprising a thumbprint reader area upon the electronic thumbprint device, where the thumbprint reader is configured to identify a pre-entered thumbprint associated with the driver.
